(19) United States
(12) Patent Application Publication
(10) Pub. No.: US 2017/0005830 A1
(43) Pub. Date: Jan. 5, 2017

(54) Demultiplexing Bonded GRE Tunnels

(71) Applicant: Futurewei Technologies, Inc., Plano, TX (US)

(72) Inventors: Mingui Zhang, Shenzhen (CN); Behcet Sarikaya, Wylie, TX (US); Lianshu Zheng, Shenzhen (CN)

(21) Appl. No.: 15/198,435

(22) Filed: Jun. 30, 2016

Related U.S. Application Data
(60) Provisional application No. 62/186,597, filed on Jun. 30, 2015.

(51) Int. Cl. H04L 12/46

(52) U.S. Cl. CPC H04L 12/4633; H04L 2212/00; H04L 45/24

(57) ABSTRACT

A Hybrid Access (HYA) network for communicating between a Hybrid Access Gateway (HAG) and a Hybrid Access Customer Premises Equipment (HCPE) using a fixed wired connection and a wireless connection is presented. The HAG demultiplexes messages of bonded Generic Routing Encapsulation (GRE) tunnels using a bonding key value, which is provided to the HCPE during bonded tunnel establishment. Communications through the bonded tunnels insert at least a portion of the bonding key value in a GRE Header, using the different bonding key values for the fixed wired connection and the corresponding wireless connection. The HAG groups messages from multiple connections of multiple HCPEs using the bonding key value in the GRE Header.

### CROSS-REFERENCE TO RELATED APPLICATIONS

This application is a non-provisional application of U.S. Provisional Application No. 62/186,597, filed Jun. 30, 2015, entitled “Demultiplexing Bonded GRE Tunnels” by Mingui Zhang, et al., which is hereby incorporated in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A Hybrid Access (HYA) network offers customers increased access capacity and improved reliability using both fixed connections and wireless connections. When a traffic volume exceeds an available bandwidth of the fixed connection, the excess traffic can be offloaded to the wireless connection. A typical hybrid access solution identifies tunnels with a dedicated bit, which is not part of a standard process and is non-scalable. For example, a hybrid access Generic Routing Encapsulation (GRE) tunneling bonding solution is implemented and deployed by Deutsche Telekom in Germany. GRE encapsulation is supported in the prior art, where the typical hybrid access solution demultiplexes using the “T” bit. For example, transmitter and receiver each independently set the T bit according to a predetermined setting, such a “1” for wired channel and “0” for wireless channel. However, with increased use of hybrid access solutions, there is a need for a more efficient system and method to demultiplex the additional messages and bonded tunnels.

### SUMMARY

The typical hybrid access solution of demultiplexing using the T bit limits the number of bonded channels that may be implemented in a hybrid connection. For example, communications across a fixed network and a wireless network between a Hybrid Customer Premises Equipment (HCPE) and a Hybrid Access Gateway (HAG) are limited in the number of bonded tunnels from a single HCPE due to the HAG being unable to identify which connections correspond to a particular bonded tunnel. As such, disclosed herein are various embodiments that facilitate scalable communications across a fixed network and a wireless network between a HCPE and a HAG. The hybrid communications can be implemented using a bonding key value for tunnel identification and packet demultiplexing.

An exemplary method for demultiplexing packets of bonded GRE tunnels at a HAG includes receiving, by a receiver of the HAG, a set-up request message from a HCPE; generating, by a processor coupled to the receiver, a bonding key value to correspond to a connection to the HCPE, where the bonding key value comprises a first portion and a second portion; and transmitting, by a transmitter coupled to the processor, a set-up acceptance message to the HCPE, wherein the set-up acceptance message comprises an attribute having the bonding key value. The method can also include receiving, from the HCPE via the fixed wired connection and the wireless connection, control messages comprising a GRE Header having a key field, wherein a key value in the key field is the first portion of the bonding key value. The control messages from the fixed wired connection are grouped with a corresponding wireless connection based on the key value.

The bonding key value is set by the HAG and provided to the HCPE. The HCPE applies a first portion of the number as an identifier in a GRE Header to identify the connection from a plurality of connections to the HCPE. The HAG receives multiple packets and demultiplexes the packets based in part on the first portion tunnel identifier. Furthermore, the first portion of the bonding key value currently corresponding to the connection is set to not conflict with a first portion of a second bonding key value currently corresponding to a second connection to the HCPE. The second portion of the bonding key value can be applied as a packet attribute for authentication purposes.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a hybrid access network architecture in accordance with various embodiments;

FIG. 2 is a schematic diagram of a network element (NE) within a hybrid access network in accordance with various embodiments;

FIG. 3 illustrates demultiplexing control messages using a key value in accordance with various embodiments;

FIG. 4 illustrates messaging flows between a Hybrid Customer Premises Equipment (HCPE) and a Hybrid Access Gateway (HAG) for establishing hybrid communications in accordance with various embodiments;

FIG. 5 illustrates a method of demultiplexing messages of bonded Generic Routing Encapsulation (GRE) tunnels in accordance with various embodiments;

FIG. 6 is an encoding of a bonding key value attribute in accordance with various embodiments;

FIG. 7 is an encoding of a Client Identification Name (CIN) attribute in accordance with various embodiments; and

FIG. 8 is an encoding of a Digital Subscriber Line (DSL) Synchronization rate attribute in accordance with various embodiments.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments designed to facilitate communications across a fixed network and a wireless network between a Hybrid Customer Premises Equipment (HCPE) and a Hybrid Access Gateway (HAG) using a bonding key value for tunnel identification and packet demultiplexing. The bonding key value is set by the HAG and provided to the HCPE. The HCPE applies a first portion of the number as an identifier in a GRE Header. The HAG receives multiple packets and demultiplexes the packets based in part on the first portion tunnel identifier. The second portion of the bonding key value can be applied as a packet attribute for authentication purposes.

Network operators may provide subscribers with separate access to fixed broadband networks and wireless networks. However, it may also be desirable in some cases to bond fixed and wireless networks together into a Hybrid Access (HYA) network to offer customers increased access capacity and improved reliability. When a traffic volume exceeds an available bandwidth of the fixed connection, the excess traffic can be offloaded to the wireless connection. Hybrid Access includes bonding of two access connections based on heterogeneous technologies (e.g., digital subscriber line and Long Term Evolution (LTE)). Accordingly, Hybrid Access supports bonding fixed connections and wireless connections together to form the bonding connection. The HCPE is a node at the customer side configured to support the fixed and wireless connections, such as simultaneous use of both fixed broadband and 3^{rd} Generation Partnership Project (3GPP) access connections. The HAG is a network function/node that resides in the provider's networks configured to implement a bonding mechanism for customer access services and to terminate the bonded connections.

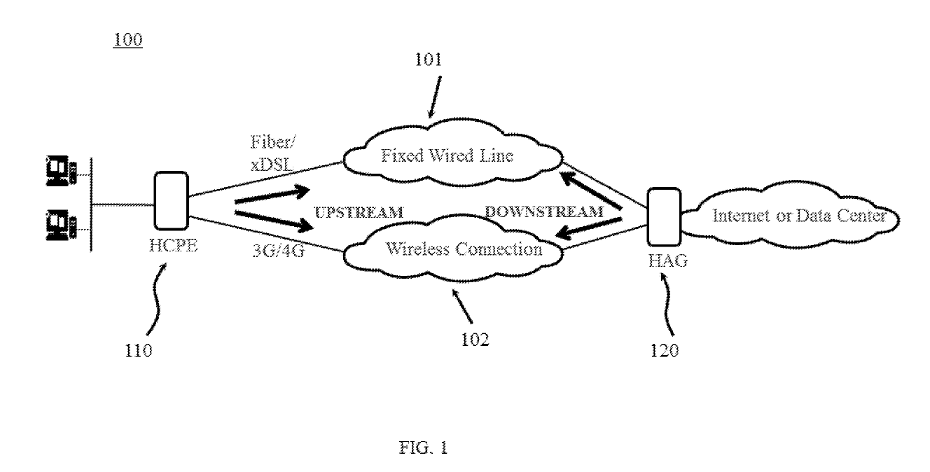

FIG. 1 is a schematic diagram of a hybrid access network architecture in accordance with various embodiments. In accordance with various embodiments and with reference to FIG. 1, a HYA network 100 comprises an HCPE 110 coupled to a HAG 120 via both a fixed network 101 and a wireless network 102. The fixed network 101 can comprise a wired or landline network, for example. The fixed network 101 can be a digital subscriber line (DSL) network or fiber optic network. The wireless network 102 can be a cellular network, a Long Term Evolution (LTE) network, 3^{rd} Generation (3G) network, 4^{th} Generation (4G) network, or any other wireless network. Although the fixed network and wireless network can be various types of networks, for simplicity the embodiments herein will be described using the DSL network as the fixed network and an LTE network as the wireless network. The DSL network 101 can comprise access nodes (ANs) and service nodes (SNs). The LTE network 102 can comprise an Evolved Node B (eNodeB) and an Evolved Packet Core (EPC).

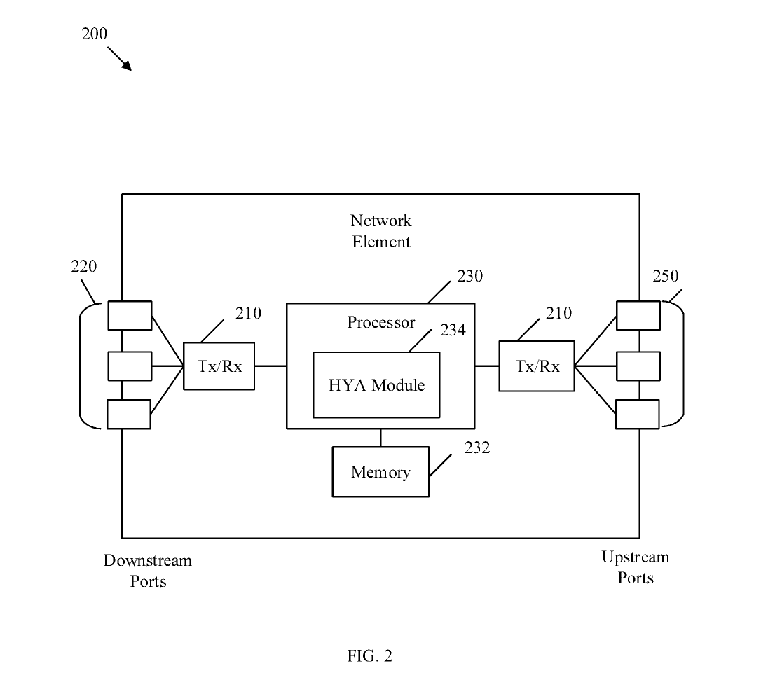

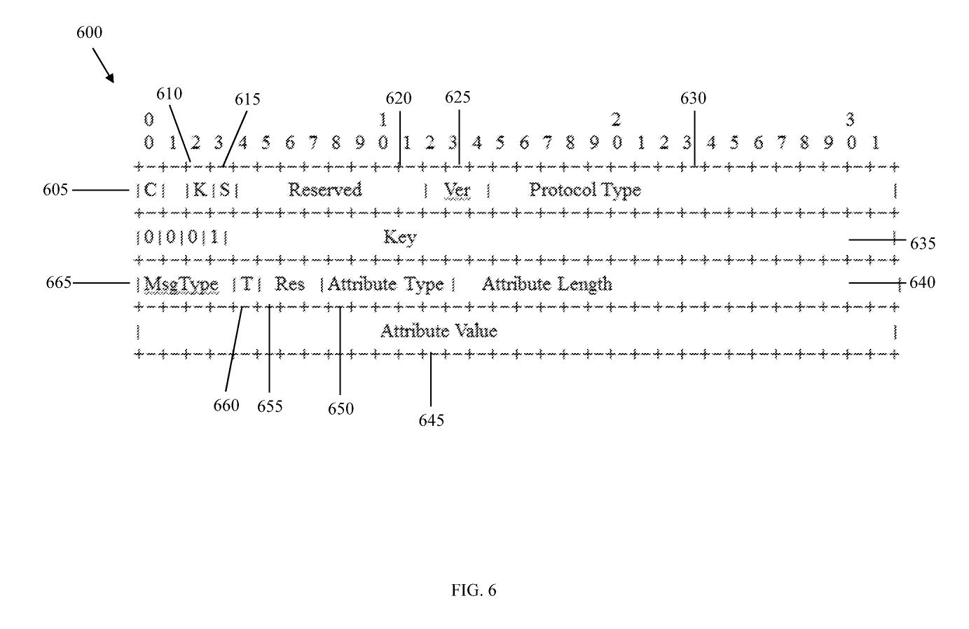

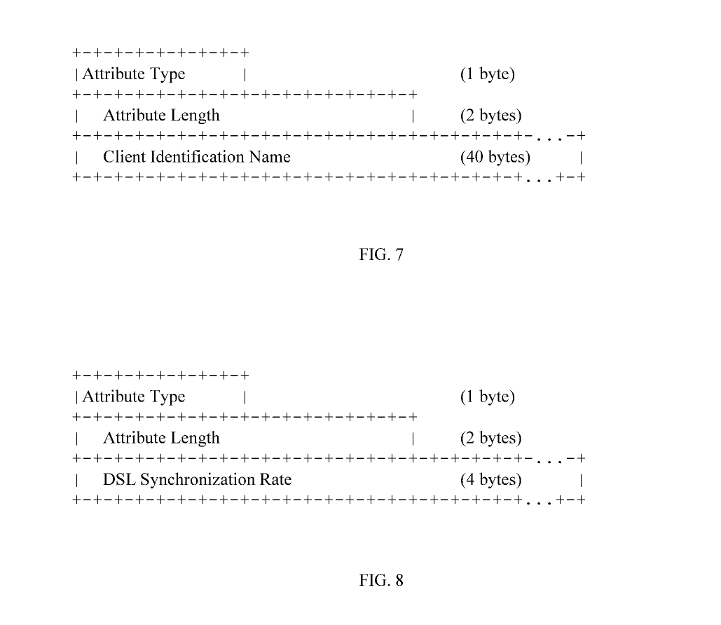

FIG. 2 is a schematic diagram of an embodiment of a network element (NE) 200 within a HYA network, such a HAG or a HCPE. For example, NE 200 may be configured to setup, tear down, and employ LTE and DSL tunnels across a HYA network of FIG. 1 by employing the attributes shown in FIG. 6, FIG. 7, or FIG. 8. NE 200 may be implemented in a single node or the functionality of NE 200 may be implemented in a plurality of nodes. One skilled in the art will recognize that the term NE encompasses a broad range of devices of which NE 200 is merely an example. NE 200 is included for purposes of clarity of discussion, but is in no way meant to limit the application of the present disclosure to a particular NE embodiment or class of NE embodiments. At least some of the features/methods described in the disclosure may be implemented in a network apparatus or component such as the NE 200. For instance, the features/methods in the disclosure may be implemented using hardware, firmware, and/or software installed to run on hardware. The NE 200 may be any device that transports frames through a network, e.g., a switch, router, bridge, server, a client, etc. As shown in FIG. 2, the NE 200 may comprise transceivers (Tx/Rx) 210, which may be transmitters, receivers, or combinations thereof. A Tx/Rx 210 may be coupled to a plurality of downstream ports 220 (e.g. downstream interfaces) for transmitting and/or receiving frames from other nodes and a Tx/Rx 210 may be coupled to a plurality of upstream ports 250 (e.g. upstream interfaces) for transmitting and/or receiving frames from other nodes, respectively. A processor 230 may be coupled to the Tx/Rxs 210 to process the frames and/or determine which nodes to send frames to. The processor 230 may comprise one or more multi-core processors and/or memory devices 232, which may function as data stores, buffers, etc. Processor 230 may be implemented as a general processor or may be part of one or more application specific integrated circuits (ASICs) and/or digital signal processors (DSPs). Processor 230 may comprise a HYA module 234, which may implement all or part of the methods and/or mechanisms discussed herein such demultiplexing control messages of bonded GRE tunnels, setting up and tearing down DSL/LTE GRE tunnels, managing GRE tunnel bonding, etc. In an alternative embodiment, the HYA module 234 may be implemented as instructions stored in memory 232, which may be executed by processor 230, or implemented in part in the processor 230 and in part in the memory 232. In another alternative embodiment, the HYA module 234 may be implemented on separate NEs. The downstream ports 220 and/or upstream ports 250 may contain electrical and/or optical transmitting and/or receiving components.

It is understood that by programming and/or loading executable instructions onto the NE 200, at least one of the processor 230, HYA module 234, Tx/Rxs 210, memory 232, downstream ports 220, and/or upstream ports 250 are changed, transforming the NE 200 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer that can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

GRE is a tunneling protocol that can encapsulate a wide variety of network layer protocols inside virtual point-to-point links over an Internet Protocol (IP) network. In various embodiments, GRE Tunnel Bonding is an enabling approach for Hybrid Access where GRE tunnels are set up per heterogeneous connections (e.g. DSL and LTE connections) between the HCPE and the HAG in the HYA network. The GRE tunnels are further bonded together to form a logical GRE tunnel for a customer. The HCPE may conceal the use of the GRE tunnels from users, such that users treat the logical GRE tunnel as a single IP link. This provides an overlay such that user IP packets (e.g. inner IP) are each encapsulated with GRE, which is in turn carried over an IP network (e.g. outer IP).

The GRE solution is suitable for HYA based on a per-packet traffic distribution mechanism. In addition, the types of packet distribution rules over hybrid accesses are deployed on both the HCPE and the HAG according to various criteria (e.g., fixed network load, failures, service list, etc.). For the purpose of measurement, control messages can also be forwarded on bonded GRE tunnels.

In accordance with various embodiments, the HAG provides a bonding key value for the HCPE to use as an identifier for transmitted packets. The bonding key value is generated by the HAG and can be employed for the purpose of security, as well as demultiplexing of tunnels. In various embodiments, the HAG generates different bonding key values for each different bonded tunnel. The different bonded tunnels may be connected to one or more different HCPEs. The HAG may identify the bonded GRE tunnels by their source IP addresses which are carried in outer IP Headers.

In various embodiments, the HAG generates the bonding key value to correspond to a specific bonded tunnel, the bonding key value comprising a first portion and a second portion. The bonding key value can be transmitted to the HCPE, where the HCPE partitions the number into the first portion and the second portion. The first portion of the bonding key value can be used to identify the bonded tunnel, and is set as an identifier by the HAG. Further, the first portion of the bonding key value is set to not conflict with a first portion of a second bonding key value currently corresponding to a second bonded tunnel. Additionally, in various embodiments, the second portion of the bonding key value is a random number and may be used for authentication and/or security applications. By way of example, the bonding key value may be 32-bits long with the first portion being 4-bits and the second portion being 28-bits. The 4-bit first portion can be used to identify up to 16 distinct bonded tunnels. A different number of bits could be assigned to the first portion for scalability if more or less than 16 tunnels are needed. The specific method used to generate the bonding key value is implementation specific. For example, the HAG sets the first portion of the bonding key value and a Pseudo Random Number Generator defined in American National Standards Institute (ANSI) X9.31 Appendix A.2.4 (incorporated herein by reference) may be employed to generate the second portion of the bonding key value.

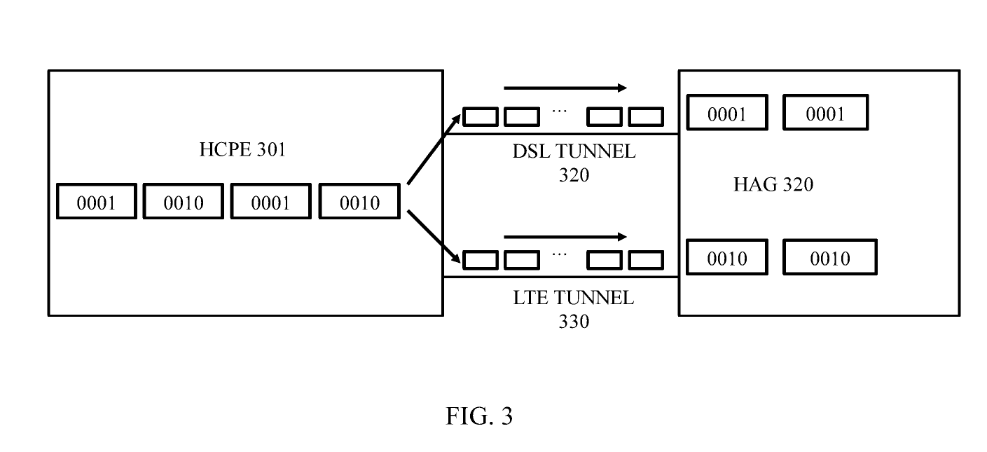

In accordance with various embodiments and with reference to FIG. 3, demultiplexing control messages using a key value are illustrated in the hybrid communication. A HCPE transmitter 301 divides the packets between a DSL tunnel 320 and a LTE tunnel 330. The HCPE transmitter may be the same as HCPE 110, the DSL tunnel 320 may be established across a DSL network similar to DSL network 101, and the LTE tunnel 330 may be established across an LTE network similar to LTE network 102. For example, first and third packets can be sent through the DSL tunnel 320. Similarly, second and fourth packets can be sent through the LTE tunnel 330. A HAG receiver 302 receives the distributed packets from the DSL tunnel 320 and the LTE tunnel 330 to form the control message. The HAG receiver 302 may be the same as HAG 120. The HAG receiver 302 may have multiple bonded tunnel connections with HCPE transmitter 301 and/or additional HCPE transmitters (not shown). Thus, the HAG receiver 302 determines which bonded tunnel the received control packets belong to using the first portion of the bonding key value.

To achieve desired performance, communications between the HCPE and the HAG are employed to achieve GRE tunnel setup, bonding, and management, while deploying and controlling consistent traffic distribution for efficient use of network resources. In addition, packet reorder, reassemble, and fragmentation issues may be settled based on this communication. A clean-slate control protocol can be designed to manage GRE tunnels that are setup per heterogeneous connections between the HCPE and the HAG (e.g. LTE and DSL). A compact control plane for Hybrid Access may be employed. With a newly defined control plane, the GRE tunnels between the HCPE and the HAG can be established, managed, and released automatically without the involvement of human operators.

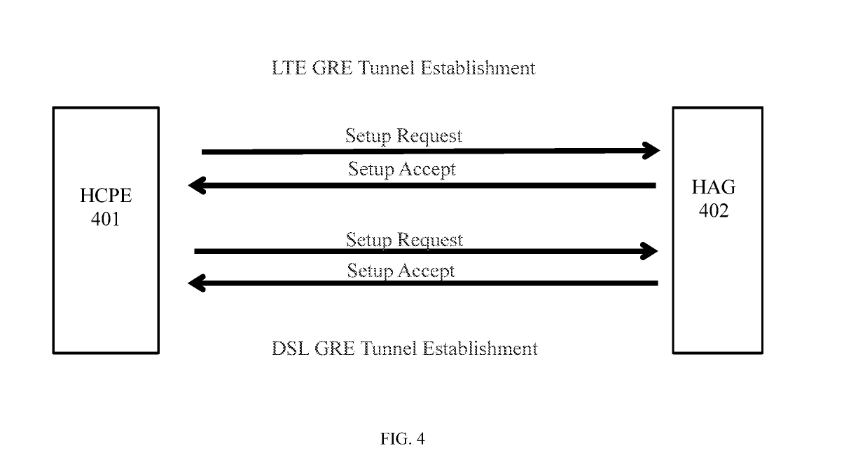

In accordance with various embodiments and with reference to FIG. 4, the GRE bonded tunnels between a HAG 402 and a HCPE 401 can be established using a GRE Tunnel Setup Request message and a GRE Setup Accept message. The HCPE 401 sends a GRE Tunnel Setup Request message to request that the HAG 402 establish the GRE tunnels. The GRE Tunnel Setup Request message is sent from the HCPE's LTE and DSL interfaces separately. The HAG 402 employs a GRE Tunnel Setup Accept message as a response to the GRE Tunnel Setup Request message. The GRE Tunnel Setup Accept message indicates tunnel establishment permission and carries parameters of the GRE tunnels. The HAG 402 may be the same as HAG 120 and HAG receiver 302. Similarly, the HCPE 401 may be the same as HCPE 110 and HCPE transmitter 301. For additional control messages and attributes specification, see N. Leymann, C. Heidemann, and et al, “GRE Notifications for Hybrid Access”, draft-lhwxz-gre-notifications-hybrid-access-01, Jan. 14, 2015, which is hereby incorporated by reference.

As part of the GRE Tunnel Setup Request message, the HCPE 401 can include a DSL Synchronization Rate attribute, which is sent only on the DSL GRE tunnel. Similarly, the HCPE 401 can include a Client Identification Name (CIN) attribute, which is sent only on a LTE GRE tunnel. When the HAG 402 receives either of the above two attributes via the GRE Tunnel Setup Request message, it can generate the bonding key value to identify each interface connected to either DSL GRE tunnel or LTE GRE tunnel. In various embodiments, the HAG 402 notifies the HCPE 401 of the bonding key value through the GRE Tunnel Setup Accept message. From that point, the first portion of the bonding key value is set as a key value in a key field for communication through the GRE tunnel. This applies to all control messages sent by either the HAG 402 or the HCPE 401. In various embodiments, the HAG 402 generates the bonding key value automatically and provides to the HCPE 401. The HCPE 401 does not generate any part of the bonding key value.

Both the LTE GRE Tunnel Setup Accept message and the DSL GRE Tunnel Setup Accept message may include the bonding key value attribute. In accordance with various embodiments, the bonding key value attribute may comprise an attribute type set to 20 to indicate a bonding key value attribute, an attribute length set to 4, and a bonding key value field comprising a 32-bit number generated by the HAG 402. Different tunnels are allocated with different key values. The HAG 402 may set aside a few bits (e.g., the highest 4 bits) in the key field as the demultiplexer for the tunnels while other bits are filled in with a value generated by a random number generator. In one embodiment, the bonding key value is set having a “1” first bit if the DSL GRE Tunnel Setup Accept message is sent first, and a “0” first bit if the LTE GRE Tunnel Setup Accept message is sent first.

Furthermore, communication between the HAG 402 and the HCPE 401 can also include a Notify message, a Hello message, a Tunnel Failure Detection message, and a GRE Tear Down message. The Notify message can be used to inform of status or other information between the HCPE 401 and the HAG 402. The GRE Tear Down message can be used by the HAG 402 to terminate the bonded GRE tunnel, including both the GRE LTE tunnel and the GRE DSL tunnel. Each communication between the HAG 402 and the HCPE 401 may consist of packets including an IP Header, a GRE Header, and the payload.

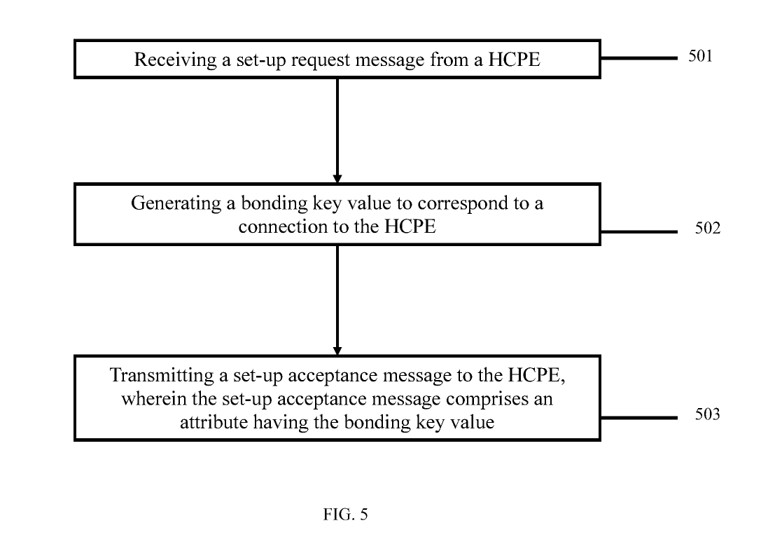

Before hybrid communications occur between a HAG, such as HAGs 120, 302, 402, and an HCPE, such as HCPE 110, 301, 401, further action must be taken after the GRE tunnels are established. After the GRE tunnels are established, control packets are sent from the HCPE 401 to the HAG 402, where the multiple packets are demultiplexed. In accordance with various embodiments and with reference to FIG. 5, an exemplary method 500 of demultiplexing packets of bonded GRE tunnels at a HAG comprises receiving, by a receiver, a set-up request message from a HCPE (Step 501); generating, by a processor coupled to the receiver, a bonding key value to correspond to the HCPE (Step 502); and transmitting, by a transmitter coupled to the processor, a set-up acceptance message to the HCPE (Step 503). The set-up acceptance message comprises an attribute having the bonding key value. In various embodiments, the method can further comprise receiving, from the HCPE via a fixed wired connection and a wireless connection, control messages comprising a GRE Header having a key field, where a key value in the key field is the first portion of the bonding key value. Moreover, the method can further comprise grouping control messages from the fixed wired connection to a corresponding wireless connection based on the key value as described with reference to FIG. 3.

FIG. 6 is a schematic diagram of an exemplary header 600 for a control message. The control message is described in “Supporting User Flow Mobility in GRE Notifications for Hybrid Access,” IETF Networking Working Group, Jun. 17, 2015, which is incorporated by reference. The header 600 comprises a Checksum Present bit (C) field 605, a Key Present bit (K) field 610, a Sequence Number Present bit (S) field 615, a reserved field 620, a version (Ver) field 625, a protocol type field 630, a key field 635, an attribute length field 640, an attribute value field 645, an attribute type field 650, a reserved (Res) field 655, a tunnel type (T) field 660, and a message type (MsgType) field 665. The numbers 0-3 above the header 600 indicate byte placement of the fields, the numbers 0-9 indicate bit placement of the fields, and the fields follow sequentially down. Thus, for instance, the version field 625 is located in bits 3-5 of byte 1. The C field 605, the K field 610, the S field 615, the reserved field 620, the version field 625, and the protocol type field 630 make up the first 4 bytes of the header 600. The key field 635 makes up the second 4 bytes of the header 600. The message type field 665, the tunnel type field 660, the reserved field 655, the attribute type field 650, and the attribute length field 640 make up the third 4 bytes of the header 600. The attribute value field 645 makes up the fourth 4 bytes of the header 600.

The C field 605 indicates whether a checksum value is included in the header. The K field 610 indicates whether a key field is present in the header. The S field 615 indicates whether a sequence number is present in the header. The reserved field 620 is reserved for future assignment. The protocol type field 630 identifies the control protocol for the HYA network 100. For instance, the protocol type field 630 identifies the GRE protocol using the value 0x0101.

The key field 635 comprises a bonding key value. When the HAG 120 receives a message, it verifies the bonding key value. As described herein, the first portion of the bonding key value identifies the corresponding bonded tunnel. The HAG can determine if the remaining portion of the bonding key value matches a stored value. In various embodiments, if the remaining portion of the bonding key value does not match the stored value, then the HAG 120 discards the message. If the remaining portion of the bonding key value does match the stored value, then the HAG 120 further processes the message.

The attribute length field 640 identifies a length in bits or bytes of the attribute value field 645. The attribute type field 650 identifies a type of an attribute in the attribute value field 645. The attribute value field 645 identifies a value of an attribute. Additional discussion of the values of attributes is disclosed in U.S. Provisional Application No. 62/185,007, filed Jun. 26, 2015, entitled “Supporting User Flow Mobility in GRE Notifications for Hybrid Access” by Behcet Sarikaya, et al., which is hereby incorporated in its entirety.

As mentioned above, the HAG may employ the bonding key value attribute to distinguish between the GRE tunnels. In various embodiments, since the CIN attribute may only be carried in the GRE Tunnel Setup Request message sent on the LTE GRE tunnel, the HAG can determine the source IP address used for the LTE GRE tunnel from the message carrying the CIN attribute. Similarly, the HAG can determine the source IP address used for the DSL GRE tunnel from the GRE Tunnel Setup Request message carrying the DSL Synchronization Rate attribute.

FIG. 7 is an embodiment of an encoding of a CIN attribute. The CIN attribute may be employed to identify the HCPE. The HCPE may send the CIN to HAG for authentication and authorization as specified in “3GPP TS23.401 version 12.2.0, General Packet Radio Service (GPRS) enhancements for Evolved Universal Terrestrial Radio Access Network (E-UTRAN) access”, September 2013, which is incorporated by reference. The GRE Tunnel Setup Request message sent out from the LTE interface contains the CIN attribute while the GRE Tunnel Setup Request message sent out from the DSL interface does not contain this attribute. In various embodiments, the CIN attribute contains a type set to 3 to indicate the attribute is a CIN, a Length set to 40, and a CIN field comprising a 40 byte American National Standards Institute (ANSI) string value that may be set by the operator. The CIN is used as the identification of the HCPE in the operator's network.

FIG. 8 is an embodiment of an encoding of a DSL Synchronization rate attribute. The HCPE employs the DSL Synchronization Rate to notify the HAG of the downstream bandwidth of the DSL link. A DSL GRE Tunnel Setup Request message may include the DSL Synchronization Rate attribute. The LTE GRE Tunnel Setup Request message may not include the DSL Synchronization Rate attribute. In various embodiments, the DSL Synchronization Rate attribute may comprise a type set to 7 to indicate the attribute is a DSL Synchronization Rate attribute, an Attribute Length set to 4, and a DSL Synchronization Rate field comprising a 4 byte unsigned integer with the unit of kilobytes per second (kbps).

In order to measure the performance of connections, control packets may need to be routed along the same paths with the data packets. Therefore, a GRE Channel may be opened for the purpose of data plane forwarding of control plane packets. By way of example, the GRE Header may be as specified in G. Dommety, “Key and Sequence Number Extensions to GRE”, RFC 2890, September 2000, which is incorporated by reference. In various embodiments, a GRE Protocol Type can be used to identify the GRE Channel. A family of control messages are each encapsulated with a GRE Header and carried over this channel. Attributes, formatted in Type-Length-Value (TLV) style, can be further defined and included in each control message as described above.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A Hybrid Access Gateway (HAG), comprising:
a receiver configured to receive a set-up request message from a Hybrid Access Customer Premises Equipment (HCPE);
a processor coupled to the receiver and configured to generate a bonding key value to correspond to a connection of a plurality of connections to the HCPE, wherein the bonding key value comprises a first portion and a second portion; and
a transmitter coupled to the processor and configured to transmit a set-up acceptance message to the HCPE, wherein the set-up acceptance message comprises an attribute having the bonding key value.

2. The HAG of claim 1, wherein the first portion of the bonding key value is set by the HAG to identify the connection of the plurality of connections to the HCPE.

3. The HAG of claim 2, wherein the first portion of the bonding key value currently corresponding to a first connection to a HCPE is set to not conflict with the first portion of a second bonding key value currently corresponding to a second connection to the HCPE.

4. The HAG of claim 1, wherein the second portion of the bonding key value is a random number.

5. The HAG of claim 1, wherein the HAG is in communication with the HCPE via a fixed wired connection and a wireless connection.

6. The HAG of claim 5, wherein the fixed wired connection is at least one of a digital subscriber line (DSL) network and fiber optic network, and wherein the wireless connection is at least one of a 3^{rd} generation (3G) network, a 4^{th} generation (4G) network, and a Long Term Evolution (LTE) network.

7. The HAG of claim 5, wherein the receiver receives, from the HCPE via the fixed wired connection and the wireless connection, control messages comprising a Generic Routing Encapsulation (GRE) Header having a key field, and wherein a key value in the key field is the first portion of the bonding key value.

8. The HAG of claim 7, wherein the processor is configured to demultiplex the control messages by grouping control messages from the fixed wired connection to a corresponding wireless connection based on the key value.

9. The HAG of claim 1, wherein the receiver receives control messages from a plurality of tunnels to the HCPE, and wherein the HAG identifies a tunnel source of the control messages from key fields in the control messages.

10. The HAG of claim 9, wherein each control message of the control messages comprises a Generic Routing Encapsulation (GRE) Header having a key field having a first portion of the bonding key value, and wherein the HAG uses the first portion of the bonding key value to identify the tunnel source.

11. A Hybrid Access Customer Premises Equipment (HCPE) comprising:
a receiver;
a transmitter; and
a processor coupled to the receiver and transmitter and configured to cause the HCPE to:
communicate with a Hybrid Access Gateway (HAG) over Hybrid Access (HYA) network via Digital Subscriber Line (DSL) Generic Routing Encapsulation (GRE) tunnels and (LTE) GRE tunnels; and
bond the DSL GRE tunnels and the LTE GRE tunnels into a logical link to support switching traffic flows between the DSL GRE tunnels and the LTE GRE tunnels based on network traffic conditions.

12. The HCPE of claim 11, wherein the processor is further configured to exchange network information with the HAG via a bonding key value attribute comprising a value indicating a password to be used as a Key of a GRE Header for each tunnel control message.

13. The HCPE of claim 12, wherein the processor is further configured to exchange the network information with the HAG via a message comprising a Client Identification Name (CIN) attribute comprising a value indicating an operator network associated with the HCPE.

14. The HCPE of claim 12, wherein the processor is further configured to exchange the network information with the HAG via a message comprising a DSL Synchronization Rate attribute comprising a value indicating a downstream bandwidth of a DSL link.

15. A method for demultiplexing packets of bonded Generic Routing Encapsulation (GRE) tunnels at a Hybrid Access Gateway (HAG), comprising:
receiving, by a receiver of the HAG, a set-up request message from a Hybrid Access Customer Premises Equipment (HCPE);
generating, by a processor coupled to the receiver, a bonding key value to correspond to a connection to the HCPE, wherein the bonding key value comprises a first portion and a second portion; and
transmitting, by a transmitter coupled to the processor, a set-up acceptance message to the HCPE, wherein the set-up acceptance message comprises an attribute having the bonding key value.

16. The method of claim 15, wherein the first portion of the bonding key value is set by the HAG to identify the connection from a plurality of connections to the HCPE.

17. The method of claim 16, wherein the first portion of the bonding key value currently corresponding to the connection is set to not conflict with a first portion of a second bonding key value currently corresponding to a second connection to the HCPE.

18. The method of claim 15, wherein the HAG is in communication with the HCPE via a fixed wired connection and a wireless connection, wherein the fixed wired connection is at least one of a digital subscriber line (DSL) network and fiber optic network, and wherein the wireless connection is at least one of a 3^{rd} generation (3G) network, a 4^{th} generation (4G) network, and a Long Term Evolution (LTE) network.

19. The method of claim 18, further comprising receiving, from the HCPE via the fixed wired connection and the wireless connection, control messages comprising a Generic Routing Encapsulation (GRE) Header having a key field, wherein a key value in the key field is the first portion of the bonding key value.

20. The method of claim 19, further comprising grouping control messages from the fixed wired connection to a corresponding wireless connection based on the key value.
